(19) United States
(12) Patent Application Publication
(10) Pub. No.: US 2003/0167465 A1
(43) Pub. Date: Sep. 4, 2003

(54) Method and system for supplementing television programming with e-mailed magazines

(76) Inventors: T. Ron Davis, Redmond, WA (US); John Woods, Woodinville, WA (US); David Gilman, Bellevue, WA (US)

Correspondence Address: Richard T. Black, Black Lowe & Graham PLLC, 816 Second Aveune, Seattle, WA, 98104, US

(21) Appl. No.: 10/027,958

(22) Filed: Dec. 20, 2001

Related U.S. Application Data
(60) Provisional application No. 60/262,471, filed on Jan. 17, 2001.
(60) Provisional application No. 60/288,264, filed on May 1, 2001.

(51) Int. Cl. H04N 7/025; H04N 7/10; G06F 3/00

(52) U.S. Cl. 725/32; 725/42

(57) ABSTRACT

An interactive television system and method for generating video programming combined with triggers and then, in turn, for viewing that video programming as the triggers present information associated with the triggers. When triggered by the viewer, the remote control will generate a request using a user interface coupled to at least one of the set top box or the television, the request being based on a user selection of the presented information associated with the triggers; that request will retrieve information at the request processing system based on the generated request; and present the retrieved information that is based on the request at a user computer system coupled to the request processing system.

### CROSS REFERENCE TO RELATED APPLICATIONS

This application claims priority from provisional application No. 60/262,471, filed Jan. 17, 2001, Attorney Docket No. RQTV-1-1002, and Application Serial No. 60/288,264, filed on May 21, 2001, Attorney Docket No. RQTV-1-1005. It also claims priority from Design Patent Application Serial No. 29/141,633, filed May 9, 2001, Attorney Docket No. RQTV-1-1003, and Design Patent Application Serial No. 29/141,634, filed May 9, 2001, with Attorney Docket No. RQTV-1-1004.

### BACKGROUND OF THE INVENTION

I. Field of the Invention

This invention relates generally to video programming and, more specifically, to interactive television.

II. Background

Over the last 25 years there has been a consensus in the television industry that consumers would watch more television if they could interact with the programming. This consensus has been expressed in the great investment by leading technology vendors such as Microsoft and Gemstar in the field of interactive television. In spite of the vast investment in this field, the efforts have not been greeted with success.

Consumer patterns have proven that televisions make poor computers and computers make poor televisions. For the average consumer, television viewing is a passive activity. Viewers do not wish to attend to the many intricacies that accompany normal computer operations such as web browsing through the same device by which they watch television.

Unlike the largely passive activity of viewing television, the use of the Internet for activities such as online shopping requires much greater attention. For this activity, the limitations of the television screen resolution and the limited interactivity available through most standard television remote control units has limited the use of a television as a browser. The dichotomy between active browsing and passive auditing of programming content has largely hobbled all of the efforts in this field of interactive television.

The largely ambivalent reaction of consumers to interactive television has not been the only factor that has slowed development in this field. In the development of interactive television there has existed a very high economic threshold for the production of interactive programming. Not only does the content producer have to develop interesting and informative television programming, but onto that programming there must be engrafted, meaningful interaction with the program. For instance, where consumers are allowed to in any way modify the ending of a story or to select from several endings, that selection requires the filming and coordination of each of the several endings. Very quickly the amount of complexity of producing video programming goes up as the square of the number of interactive opportunities presented in the interactive programming. Without identifying a new source of advertising revenue, there exists no way to ameliorate the far greater costs of interactive programming.

These two facts, the great technological expenditures in this field, and the high economic threshold for programming in this field have prevented market penetration with fully interactive television. Nonetheless, the great investment in the field has created technical know-how even where no one is able to capitalize on the existence of this know-how. Technological standards have emerged, such as that of the Advanced Television and Video Enhancement Form, or ATVEF. This standard is based on the hypertext mark-up language, or HTML. While the standard exists, no entity seems ready to exploit that standard. Because of these facts, there exists a need for an invention that recognizes the distinction between the moods of the consumer when acting as a viewer, and when acting as a browser. Further, there exists a need for a form of interactive television that exploits current technologies without imposing upon producers the greater complexity and cost of interactive television. There exists a need to unite the potential of interactivity with the viewing habits of the public.

### SUMMARY OF THE INVENTION

An interactive television system and method for generating video programming combined with triggers and then, in turn, for viewing that video programming as the triggers present information associated with the triggers. When triggered by the viewer, the remote control will generate a request using a user interface coupled to at least one of the set top box or the television. The request, being based on a user selection of the presented information associated with the triggers, will retrieve information at the request processing system based on the generated request and will present the retrieved information that is based on the request at a user computer system coupled to the request processing system.

The system allows the viewer to passively view video programming and to request such information as might interest the viewer. The appropriate conduit for receiving the information is the viewer's e-mail platform. The invention will generate and assemble information associated with the program based upon the triggers embedded in the programming.

### BRIEF DESCRIPTION OF THE DRAWINGS

The preferred and alternative embodiments of the present invention are described in detail below with reference to the following drawings.

FIG. 1 is an overview of the several phases of the system;

FIG. 2 is a view of the apparatus used at the production phase to link programming content to triggers;

FIG. 3 shows the graphic user interface on the producer's desktop software product;

FIG. 4 shows the graphic “bug” in situ on the display of an enabled television;

FIG. 5 shows the resized television picture along with the mask showing the several billboards and the several links and selection boxes;

FIG. 6 displays a demographic sorting desktop for linking the triggers in a program according the likely demographic features of the viewer;

FIG. 7 displays the methods of disseminating the enhanced programming to several viewers;

FIG. 8 displays the mechanism used to respond to requests for e-magazines;

FIG. 9 displays the sent e-magazine with several of sorts of elements that might be useful;

FIG. 10 displays the mechanism for assembling an e-magazine with special articles for the intended audience;

FIG. 11 portrays the process of registering for the service where the registration is used for initiating a demographic file for the user or users;

FIG. 12 portrays the process of producing enhanced program content for the system; and

FIG. 13 portrays the process of requesting a e-magazine.

### DETAILED DESCRIPTION OF THE PREFERRED EMBODIMENT

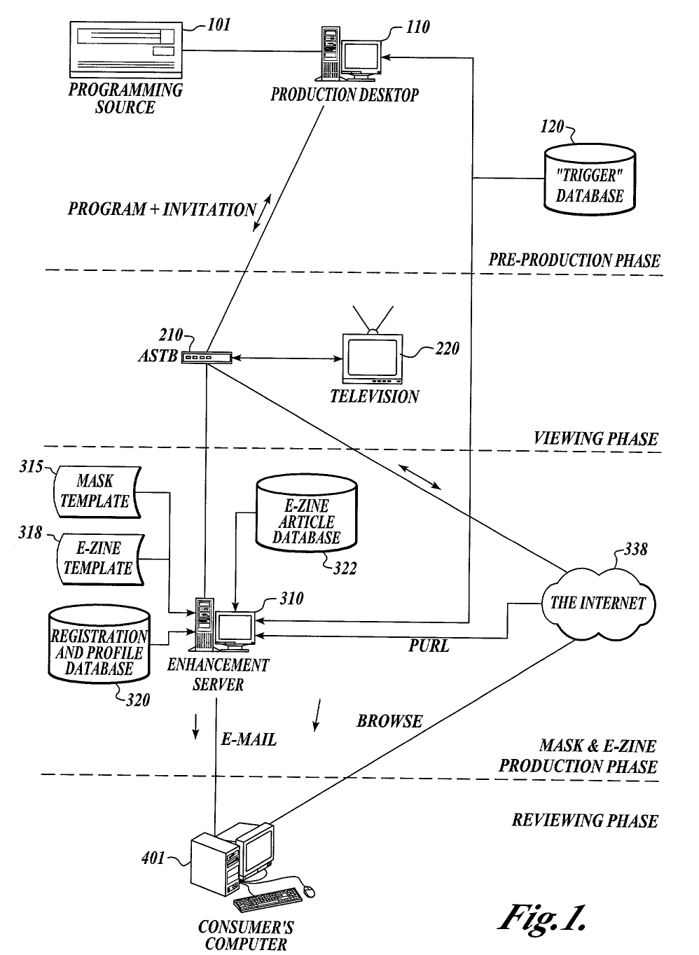

FIG. 1 represents an overview of the inventive method and system. This FIG. 1 portrays four phases in the method: the pre-production phase, the viewing phase, the mask and e-Zine production phase, and the reviewing phase. These phases are not in strict chronological order. For the viewer in the viewing phase to use the system, masks must already exist and these are produced in the mask and e-Zine production phase.

The pre-production phase begins with a programming source 101. The programming source may be any form of video programming, though most likely it is on a non-volatile medium, such as some form of tape, film, or optical disc such as a CD or DVD. The selection of a viewing source is limited only by the qualifier that it be recorded on a non-volatile source. Even flash memory sticks such as the SanDisk Compact Flash® or the Sony Memory Stick® would serve as such media. Whatever the source 101, it is the object of pre-production to add to that recorded medium appropriate triggers.

The producer of the enhanced programming draws the base program from the programming source 101 in by means of a computer (here the producer's desktop 110) imbeds a series of unique triggers into the programming by ATVEF standard means. Though not limited by the method used, this process is analogous to imbedding closed-captioning in the NTSC or PAL standard signal. Simply put, the producer places additional information that enhances the base video programming on the signal without requiring additional signal capacity. This additional information is expressed in embedded “triggers” used to generate masks available to the viewer.

The producer draws the configuration and content of the triggers from a trigger database 120. These triggers help to either define the mask itself or, as in the preferred embodiment, direct an advanced set-top box 210 to where the masks are found. In the preferred embodiment, the triggers will be uniform resource locators, or URL's. While the preferred embodiment uses URL's, any unique code can be used, such as binary or decimal codes imbedded in the programming, for it is the sole purpose of the codes to evoke from an advanced set top box 210 appropriate masks to match the programming at defined times throughout the viewing.

An example of a non-URL type code that would be workable, though not the preferred embodiment, would be a multi-place binary number that included codes to populate a masked template that would be displayed on the screen. The code itself would be merely a concatenation of discreet billboard and button codes as will be discussed in greater depth when discussing the mask. A mask template might be stored in non-volatile memory in the set-top box 210. These billboards and buttons serve to allow the viewer to interact with his television 220 by means of the advanced set top box 210. They are, in short, opportunities to make a selection. Where standard codes exist for each billboard and button, the concatenation of those codes is an effective means to carry out the inventive method and implement the inventive system.

The producer uses the production desktop 110 to meaningfully relate that which is portrayed on the screen with a series of masks. For example, should the viewer be watching a documentary movie on the shrines of Kyoto, a view of the Fushimiinari or Fox Shrine might be accompanied by billboards for various travel agencies and buttons requesting information about 1) tourism and travel in the Kyoto area; 2) the history of the Fushimiinari Shrine from 771 A.D. in Kyoto; 3) clothing appropriate for touring the Kyoto area given its climate and culture; and 4) gifts and souvenirs evocative of Kyoto, such as green tea and silk.

One advantage of the imbedding of URL triggers in the programming is that the precise way of filling out a mask is dynamic and not set at the time of pre-production. Returning to our example of a tour of the shrines at Kyoto where the pre-producer imbeds a series of URL's into the programming material and either has or creates at that time a list of descriptions for each and every “attachment point” where a URL has been imbedded, the producer may later place at the URL masks that differ in time. If, for instance, one supplier of green tea discontinues their advertising contract, a producer might substitute a different billboard on the mask stored at the URL, even though he does so months after pre-production and imbedding of the triggers is complete. The use of URL's for triggers, thus, allows the flexibility that concatenated codes or other static means of imbedding enhancements in the programming do not. A similar change is possible in the concatenated code embodiment, however the steps necessary to associate one advertiser with a given code is slightly more involved.

Once the triggers have been imbedded in the programming content, the preproducer then records the program with imbedded triggers on any suitable non-volatile medium. There is no need for correspondence between the original medium used to read the programming content and that used to record it. The pre-producer may use any medium suitable for later viewing by the viewer.

In the viewing phase a viewer receives, operates, or actuates an advanced set top box or ASTB. The advanced set top box may or may not include many of the functions of a standard cable set top box, however, the advanced set top box adds the interactivity with the system. Indeed, the inventors envision a time where the market for these services are such that television manufacturers incorporate the ASTB circuitry 210 into televisions 220. The ASTB 210 includes the ability to perceive and to read the imbedded triggers in programming regardless of where the circuitry resides.

When connected to a programming source by any conventional broadcast means, the ASTB 210 sends an invitation through an upstream communication ability back to a clearinghouse. The clearinghouse might be any sort of service provider. A multiple services operator is a corporation broadcasting more than one television network. Clearinghouses would include local cable television providers. An essential element of the set top box is the ability to communicate by some means with the clearinghouse. These means might include upstream transmission through television broadcast means, such as through coaxial cable wave-guides; transmission through hard wired telephone lines; PCS or cell phone communication; or any suitable communications link that will bring a signal back to the clearinghouse.

In response to the invitation, the clearinghouse transmits through the advanced set top box 210 to the television 220 enhanced programming as produced at the preproduction phase. The advanced set top box retains the most recent trigger broadcast in a register. The purpose of the register is to share the recent trigger needed to generate a screen for the viewer. Each time a new trigger is broadcast it replaces the trigger that was stored in the register. When the viewer makes a selection indicative of a desire to interact with the programming, the advanced set top box uses the codes stored as a trigger to generate a selections mask. If the trigger is a code representative of a URL, the advanced set top box retrieves the information stored at the URL by means of any communication channel available to the set top box to so retrieve the information. Like the upstream channel earlier described, any appropriate communications link will serve.

Where the triggers are a concatenated code, the advanced set top box draws the meaning of those triggers from the trigger database 120. This is the same database that pre-production used to identify the codes and to imbed them into the programming. From the database, the ASTB 210 draws the current billboards associated with individual code elements of the concatenated code, these it positions into a mask template stored in the ASTB 210 or alternatively in the trigger database 120. The trigger database 120 contains the contents that will fill the mask. From such information, the ASTB 210 has the necessary information to form the mask on the screen around a compressed view of the video programming.

In response to the viewer's request, the advanced set top box 210 has generated a mask. This mask presents the viewer with a number of billboards and buttons to indicate specific selections that represent requests for information. The viewer selects by appropriate means, in the preferred embodiment by means of a remote control device that allows scrolling through the buttons, those buttons representative of the viewer's request for information. When the viewer is satisfied that the selected buttons do represent the viewer's request, the viewer “transmits” the request by means of a separate selection. In the preferred embodiment, this separate selection is a button on the mask appropriately marked with a legend such as “send” or “submit”. Upon transmission, the viewing phase is complete.

Production of mask content to be presented to the viewer must be completed before the viewing phase. The production software constructs the mask by a process that is closely analogous to the production of e-Zines generated based upon the viewer's submitted requests. Both the e-Zine and the mask are based upon templates and are constructed in a similar manner.

At some point between pre-production and viewing, in the preferred embodiment, a producer takes the generated list of “attachment points” discussed above and selects buttons and billboards to associate with each of the attachment points, thereby generating screen masks. In the preferred embodiment, the URL's associated with each distinct “attachment point” are stored in the trigger database 120. After the producer has selected those billboards and buttons that will fill the mask, the producer unites those with a mask template 315 to create a mask. Once the mask is satisfactory to the producer, the producer stores the mask at the URL associated with the attachment point. By this means the producer creates a mask for each attachment point within the video programming, thereby completing the production task. In the concatenated code embodiment the mask template 315 might be stored within the advanced set top box 210 such that all of the unique features of a particular mask are set forth in the concatenated code. By this means, a code and a mask template 315 will create a proper populated mask. In such an embodiment this is accomplished at the time of imbedding triggers.

More complex is the process of creating e-Zines. To respond properly to the viewer's submitted requests, the system must include e-Zine articles associated with each potential request. Thus, if a viewer requests information about travel in Kyoto, there must exist on article database 322 an article that corresponds with that request. In a preferred embodiment there are a plurality of articles corresponding with that request and demographic factors unique to the particular viewer and stored in a registration and profile database 320 will serve to further pinpoint the choices of the viewer.

Thus, for example, when an 18-year-old viewer requests clothing suitable for touring in Kyoto, the viewer receives an article describing clothing from Abercrombie & Fitch where a 45-year-old viewer might receive an article descriptive of clothing from Nordstrom or Eddie Bauer. At length, the producer can select and associate the requests and demographics of the viewer in such a manner as to optimize marketing on the viewers they have. The viewer sees only that which would interest them.

Once the enhancement server 310 draws appropriate articles from the e-Zine article database 322 based upon the received requests from the viewer and the viewer's profile stored in the registration and profile database 320 and places those articles in the e-Zine template 318. Once the template is filled and an appropriate e-Zine results, the enhancement server places the completed e-Zine on the Internet at a unique URL. An alternate embodiment of invention includes the placement of the e-Zine at a PURL.

A PURL is a private uniform resource locator which uniquely identifies an intended recipient of a document, the document or set of documents to be delivered, and (optionally) other parameters specific to the delivery process period. The intended recipient of a document uses the PURL to retrieve the document. The server, upon retrieval of the document, customizes the behavior of the retrieval based upon attributes included in the PURL as well as log information associated with the retrieval in a database. This architecture and usage of PURL's enables secure document delivery and tracking of document receipt. PURL's are temporary, dynamically generated, uniform resource locators. Once the server notices that a specific individual has accessed the specific document, the document can be removed from the server, thereby allowing both privacy and economy of space in the database. The PURL need not be immediately removed but can have a certain latency that may be programmed by the server. The use of PURL's also allows, if desired, the use of passwords before the electronic magazine stored at the PURL can be accessed. The server may also identify the specific recipient accessing the document and check the same against those individuals having the ability to view the document. In short, security is available at this point in the process.

Once the enhancement server 310 places the e-Zine article on the Internet 338 it sends a link to the URL imbedded in an e-mail message to the viewer. The e-Zine is produced almost immediately after the selections are transferred to the enhancement server. To the viewer who makes his request and then turns off the television, the information should be available in his e-mail box in the time that it takes to move across the room to the computer. The beauty of this system is that he doesn't have to turn off the television and move across the room. The e-mails are stored in his e-mail box according to whatever e-mail system the viewer uses. When the viewer chooses to review his mail, the information will be available. As stated in the background section, this lag in time is a very desirable aspect of this invention. Experience has indicated that viewers do not wish to be troubled by the in-depth information that they have requested at the time of viewing, but rather, wish to review that information when their mood changes from that of a viewer to that of a browser. The ability to store e-mail information in one's e-mail box is what differentiates this from most interactive television that immediately demands one's attention, drawing it away from the program at hand. While there are other advantages to this invention, this one is a key distinction.

The viewer at some time after submitting the request, sits at his home computer or office computer 401 and browses his e-mail. There he finds the e-mail from the enhancement server containing the link to the e-Zine. By following that link from the email the viewer downloads the e-Zine for browsing. The articles in the e-Zine are themselves imbedded with additional links that take the viewer to additional sources of information; to stores offering particular products; to services and agencies that can arrange travel; and any of a myriad of other products, services or information sources that meet the parameters of either the expressed request of the viewer's or those presumed from the viewer's personality profile. In either regard, selected articles assure the optimum dissemination of information to viewers.

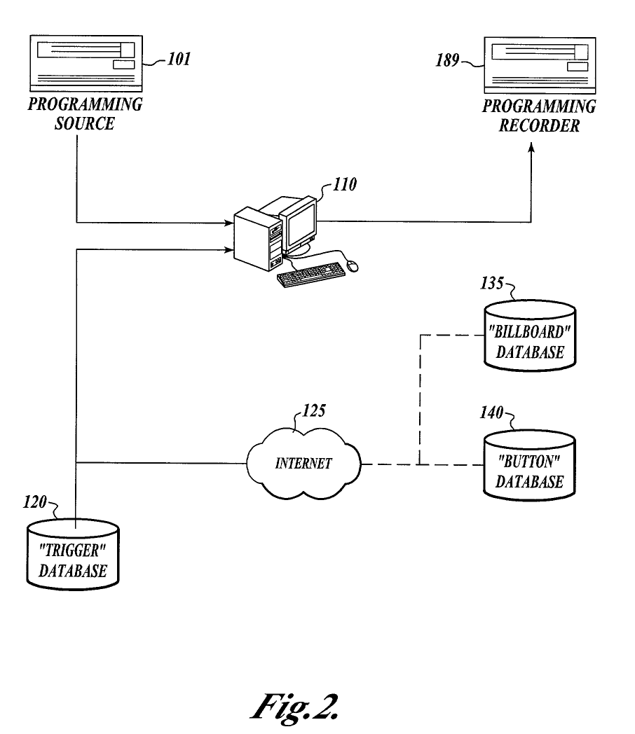

As can be readily recognized from the foregoing description of the overview of the invention, programming content need not be merely documentary films. Clearly any type of video programming, including advertisements, may carry these imbedded triggers to the advantage of the sponsor. In the contexts of commercial advertising one can readily imagine information that supplements an ad shown on the screen. Take for example the advertisement of a new model car. Let us assume for example that one of the attributes of the advertised car is that it received a J. D. Powers® rating for quality. In that instance, the triggers within the content would evoke a mask that included a button allowing the request of the J. D. Powers® report that so rated the automobile. The same would be true, perhaps, of crash-worthiness studies or any attribute of the car where presenting the documentation in the commercial might weigh down the commercial for the general viewer. In such an example it is clearly easy to see that production of one or several masks to associate with attachment points within the commercial is easy and inexpensive, but provides the potential purchaser with in-depth research likely to affirm their nascent decision to purchase the vehicle. The same is true of any product. From cookies to clothing or services to hard goods, this system and method allow for the footnoting of commercials at no great expense to the producers. The utility of the invention is clear. FIG. 2 shows the pre-production phase in-depth. As indicated above, both the programming source 101 and the programming recorder 189 simply allow for the reading and recording on non-volatile media. As indicated above, these need not be the same non-volatile media. Software loaded into the producer's desktop 110 allows the producer to imbed triggers from the trigger database into the video programming. At some juncture, some entity will generate an “attachment point” script for the video programming from the programming source 101. The purpose of the attachment point script is to describe each change of focus within the source video programming.

Continuing in the earlier example, in a tour of the shrines of Kyoto when the attention in the program (Toyokuni Jinja) to the gold pavilion (Kinkakuji Temple) the historical note button in the produced mask will represent a distinct request when selected. As the show moves on to the silver pavilion (Ginkakuji Temple) the button changes again in its meaning. The mask associated with the video programming may not change throughout as might be the case with a situation comedy such as Seinfeld or Friends. On the other hand, as in our example of the Kyoto shrines documentary, the associated mask might change quite frequently throughout the programming. The option remains with the producer or the owner of the content to attach to programming contents such attachment points and to associate with those attachment points such masks as are likely to induce the greatest viewer satisfaction, or the most successful marketing of the various products of the sponsors. In any regard, the producer finds it easy and therefore economical to attach additional content to the video programming.

In the preferred embodiment, URL's are attached at the attachment points in the video programming. Nonetheless, in the alternate embodiment, it is necessary to construct the masks at the time of production. To that end, the producer's desktop requires access to more than just the trigger database 120 but also to a billboard database 135 and a button database 140. These may be maintained at the producer's site, or the producer may have access to them through a communication link, or as shown in this FIG. 2 through the Internet 125. In this alternative embodiment the producer draws from the billboard database billboards for the sponsors of the enhanced content. These billboards are icon-like artwork to fill assigned places in the video mask and are associated with the sponsors in a manner to allow the viewer to select the billboard and receive information available through that sponsor. The billboards may or may not be active; activity is not required to practice the invention. A button database 140 exists to associate buttons with requests for information as indicated above. The producer imbeds codes in the programming with the producer's desktop 110 and thereby populates a mask template that the set top box will generate when it receives the trigger.

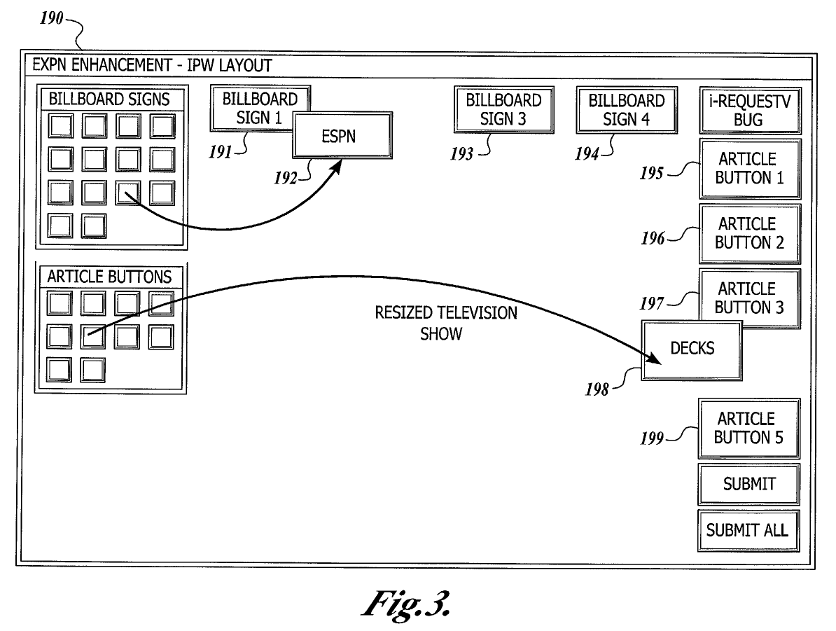

FIG. 3 portrays a screen 190 from the producer's desktop software. As the producer views the video programming in the center of the screen 190 the producer will populate masks with drag and drop icons belonging to the sponsors of the enhanced programming. These billboard signs go into slots 191, 192, 193 and 194. Similarly, the software provides article buttons to the producer to populate the article button slots 195, 196, 197, 198 and 199. The software presents a graphic user interface (GUI) allowing the producer to easily drag and drop buttons into place and to fasten the same to attachment points within the programming.

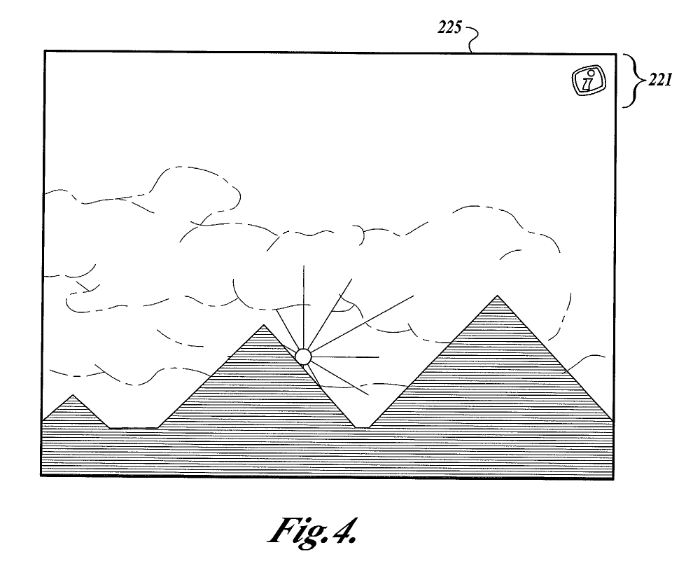

FIG. 4 displays the television screen 225 generated by the advance set top box 210. The presence of a “bug” 221 in the upper right corner of the screen indicates the advance set top box's readiness to receive the viewer's request to commence interactive operation. At any time when the bug is present the advance set top box 210 indicates that enhanced programming is present. To initiate operation the viewer indicates his selection on a remote control.

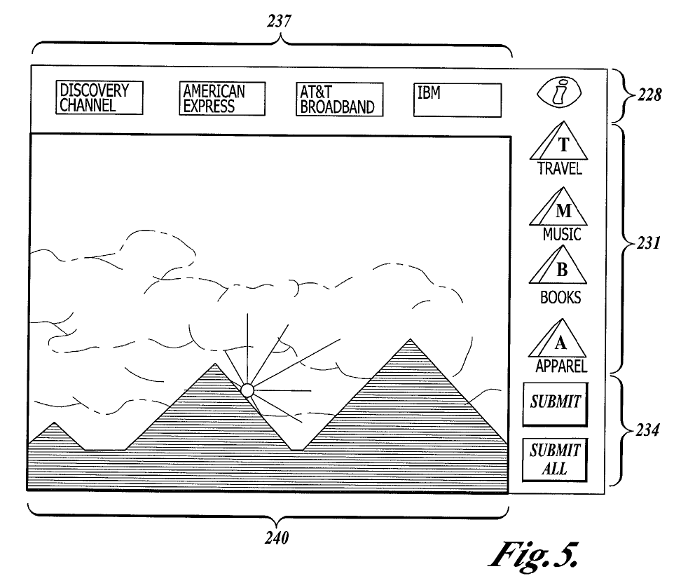

FIG. 5 portrays the mask generated or retrieved by the advance set top box 210 as a result of the viewer initiation of the interactive process. In FIG. 5 there are five principal elements portrayed. The interactive “bug” is replaced by the trademark 228. The various buttons populate the mask in the slots set forth at 231. The billboards are present in the 237 position and request buttons for submit or submitting all of the potential selections exists at 234. As earlier emphasized, one purpose of the invention is to provide a minimum distraction from the passive activity of television viewing. For this reason a slightly reduced screen appears in 240 allowing the viewer to continue to see as the principal element of the screen the video programming. It is the intent of the invention that the whole screen remain visible at a slightly lower resolution than when the mask is not present. Such a configuration removes the possibility of losing the spectacular catch during sporting events or creating the possibility of critical off screen detail. The invention seeks to avoid the effect that occurred when cinemascopic movies were broadcast on conventional television without compressing the image.

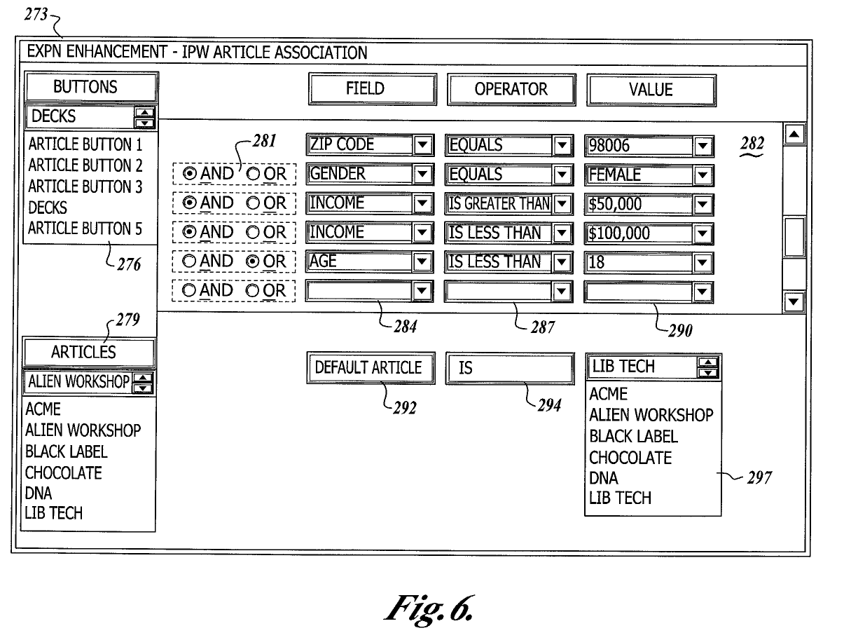

FIG. 6 portrays a second screen in the producer's desktop. This screen allows the producer to associate articles with anticipated requests by the viewer. In response to the selection of any of the buttons located at 231 in FIG. 5 the producer can select from among a plurality of articles available on a particular topic to select that article that is most likely to appeal to a particular demographic. This screen 273 comprises the associative means for the articles. At 276 the requesting means are listed. Thus the producer can indicate that in response to article button number 4, in this case named “Decks” will be associated at 279 with the article “Alien Workshop” so long as other conditions are true. Those conditions portrayed in boxes 281, 284, 287 and 290 indicate that as long as the viewer lives in Bellevue, Wash. (i.e. zip code 98006) is a female with an income of greater than $50,000 but less than $100,000 and is less than 18 years of age, they will see “Alien Workshop.” In all other instances, the default article is “LibTech” 292, 294 and 297. The number of conditions that might be placed on associating a particular article with a particular button is not limited as is indicated by the scroll bar at 282. If more conditions are necessary the scroll bar will continue downward providing additional fields, operators and values.

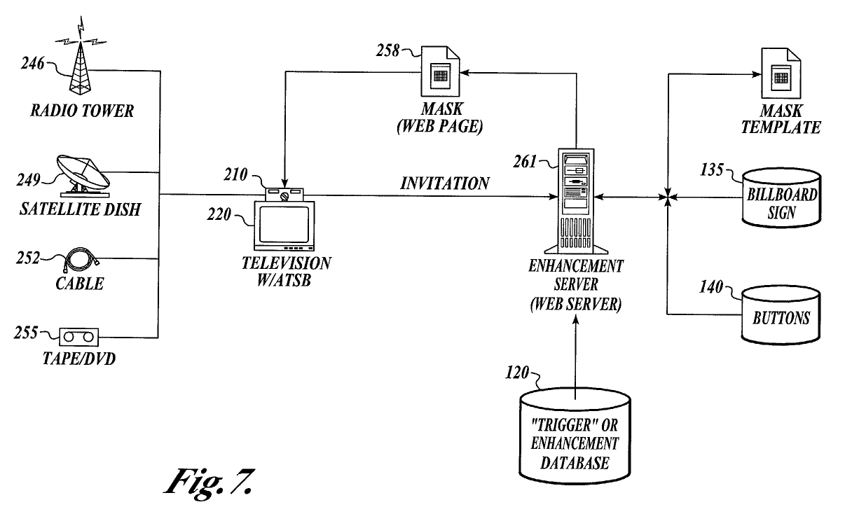

FIG. 7 shows some of the hardware necessary for the preferred embodiment of the system. In FIG. 7 the sum of several sources for enhanced video programming with imbedded triggers are apparent. Because there is no requirement that the upstream channel be the same as the downstream channel for information coming to the set top box 210, there is no requirement that the received broadcast be “live.” Thus, in the inventive system, signals might be received from a radio tower 246, a satellite dish 249, through cable distribution 252, or from recorded media such as tape or DVD 255. When the imbedded triggers are present the advance set top box 210 becomes receptive to filling masks with matter drawn from the enhancement server. At the same time the advance set top box portrays the bug 221 on the screen 220 indicating the presence of enhanced programming. At such time as the user should activate the system the register containing the most recent URL trigger directs the set top box to pull down from the enhancement server the current mask stored at the given URL as a web page. This web page the advance set top box 210 portrays on the screen 220 and awaits the viewer's selection. When the viewer selects a series of buttons from the portrayed mask 258 that selection is sent back to the server 261. The enhanced server then refers to the trigger or enhancement database 120 to understand the meaning of the selection packet received from the set top box 210.

The figure also portrays the workings of an embodiment where rather than URL's unique codes are imbedded in the programming. When the viewer requests initiation of interactive mode, the most recent code is sent from the register of the set top box 210, the concatenated code is directed at the enhancement server, the server then draws the mask template 130 and the billboard signs associated with that trigger from the billboard sign database 135. Similarly, it draws the buttons associated with that code from the button server 140 and composes a completed mask. This it sends 258 back to the set top box 210 for portrayal on the screen. As is indicated in diagram, both embodiments can work simultaneously on the server. Regardless of which of the two embodiments is employed the mask sent at 258 is a complete HTML document with a section 240 displaying a lower resolution full picture of the current video programming as portrayed in FIG. 5.

The key to the system is the providing of e-Zines to viewers in response to their selections. These e-Zines are to be tailored to the selections and also to the demographics available with regard to the individual viewers. Viewers have registered on the system and have provided demographic data about themselves which is stored in a registration profile database 065. Producers can select such demographic factors as they find necessary to effectively tie the user to a particular or several purchasing demographics. Once the user has completed the survey relating to this demographic, the user is then allowed to participate in the system. Where a household consists of multiple users, there might be a sign on screen that allows a viewer to designate which of the several users is currently watching, or at least which is requesting the service. Once enrolled and appropriately identified, the viewer watches the television 220 along with the enhanced material provided by the advance set top box 210. As between several television sets, the ASTB 210 will report which ASTB 210 is interacting with which viewer. After the mask has been displayed and the viewer has made their selections and submitted the same by activating either of the buttons at 234, that selection packet is sent to the selection server 338 one of four servers within the collective enhancement server 310. The hardware contained within the enhancement server need not be confined to a single computer, nor is it necessary that it be four computers. In fact, one skilled in the art knows how to distribute and to group the tasks described as assigned to the enhancement server among any number of computers for efficiency and load. The four computers portrayed, the selection server 338; the e-Zine compiler and server 341; the PURL allocator and server 344; and the e-mail server 347 refer in fact to different functions that are accomplished within the collective enhancement server 310. Thus as the selection packet arrives at the selection server 338, that server 338 reconstructs the selection by reference to the billboard database 135, the trigger or enhancement database 120, and the button database 140. When reconstituted, the request is then sent to the e-Zine compiler where articles are selected from the e-Zine database 335 based upon the demographic of the identified viewer as drawn from the registration and profile database 065. When compiled, the e-Zine compiler requests a URL from the URL allocator and server 344 and stores the e-Zine at that URL on the server. The URL may be dynamic such that each viewer could be served by a single URL. Simultaneously, the e-Zine compiler requests of the e-mail server that an e-mail be sent with the URL indicated by the URL allocator and server 344 to the viewer's e-mail box. Again, where multiple viewers live in a single household, the viewer's log on will indicate to which e-mail box the message is to be sent. The consumer in turn receives the e-mail on the consumer's computer 401 and using the links provided, views the e-Zine and the content therein. In turn, links contained within the e-Zine send the user back to the Internet 125 to browse the websites of various sponsors referred within the e-Zine or information sources contained in bibliographies to articles.

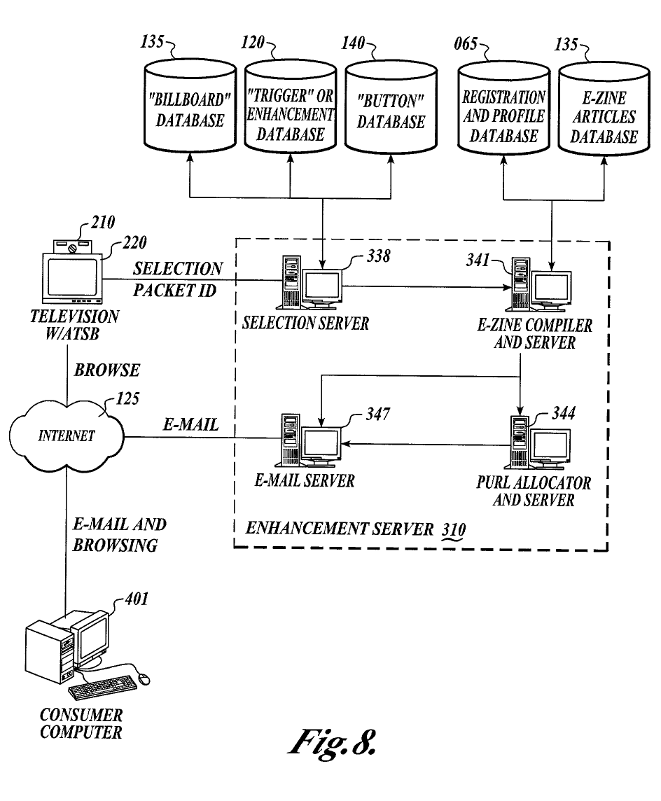

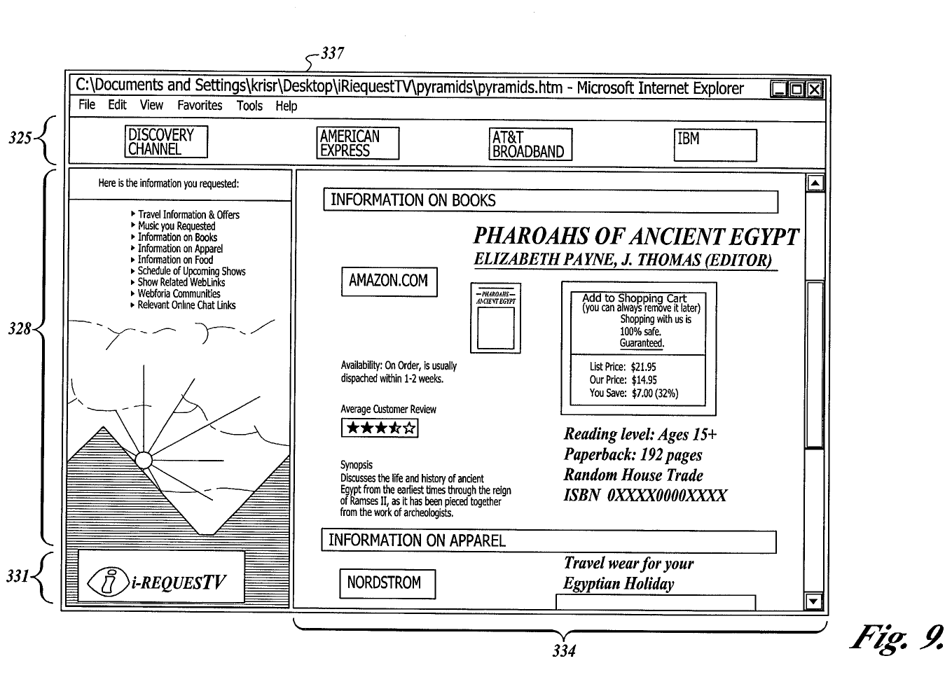

FIG. 9 shows a composed e-Zine resulting from the process set forth in FIG. 8. This e-Zine 337 also has an area for billboards 325. Though these billboards are much like those described at 228 in FIG. 5, they do not necessarily have to be the same billboards. The vagaries of sponsorship agreements may well change the composition of the billboard bar. In any regard, the bar is consistent in look and feel to the bar that was created in the mask 228. There also exists a table of contents 328 that shows the e-Zine to be responsive to the requests set forth in the selection packet as it was delivered to the enhancement server 310. In this instance buttons requesting travel information and offers; music; books; apparel; and food; as well as information related to the selection of one of the bulletin boards, i.e. the Discovery Channel. Additionally, there may be standard features such as links to interest communities or to chat groups related to what was on screen at the “attachment point.” Pane 334 is the information requested. That pane will move independently so that both the billboard bar 325 and the table of contents 328 remain visible, as well as branding reminding the viewer of the source of the e-Zine 331. As the user scrolls down they allow opportunities to purchase the products relevant to the “attachment point.”

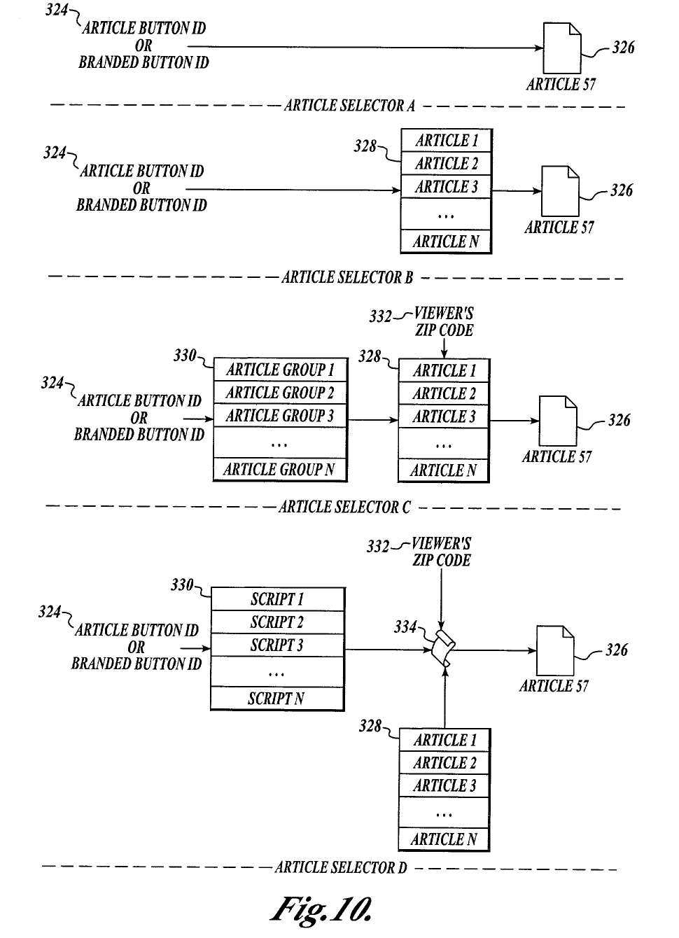

FIG. 10 yields insight as to the means by which the compiler compiles articles. The selection packet is a series of single selection id's 324. In most instances, as in article selector A, all demographic groups would receive the same article 57 326. In example B of the article selector, an external factor, for instance the season of the year, is used to select from among a series of articles at 328. As in example A, article 57 326 corresponds with the article selection 324. In still another example, article selector C may indicate a group of articles, in this case article group 3, then the viewer's zip code 332 is considered by the compiler because the producer has associated particular articles with particular zip codes. Thus in this case again article 57 326 is selected by virtue of the sort and association designated by the producer. As shown in FIG. 6, multiple demographic data can further refine the selection process. Example D of the article selector shows where an article button 324 defines a script, in this case script 3, as applicable. Script 3 in turn along with the viewer's zip code 332 results in a sorting process 334 that winnows the field down to article 57 326.

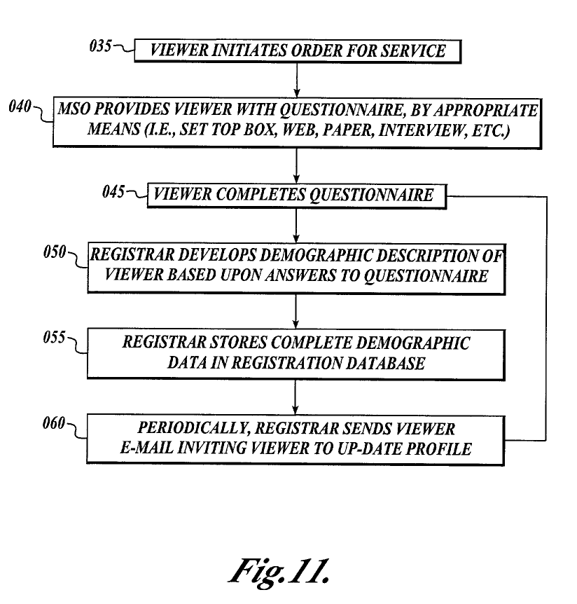

FIG. 11 portrays the method used to register for the system. At 035 the viewer initiates an order for service, or enrolls. There are several ways this could be effected: the viewer might call the clearinghouse and as a part of the enrollment the operator might administer a questionnaire over the telephone 040; the viewer may order the service at a website where part of the ordering includes completing the questionnaire on the website; the clearinghouse may send a questionnaire to the viewer in a welcome to the service package; or, any number of other means to discern the demographic factors that define the viewer. When the viewer completes the questionnaire 045 the data is entered on the server. The registrar which may be a human, a software agent, or a systematic method based on the viewer's completed questionnaire builds a profile representative of the viewer's demographic. At 055 the registrar stores the complete demographic profile in the registration database. As described above, that profile is used to determine which articles, goods and services are presented to the viewer through the service. Periodically 060 it will be necessary to update the profile. Many demographics are variable over time, such as the age of the viewer. Other things, such as income, also change. The viewer is probably well motivated to make these changes, thereby allowing the service to provide the viewer with articles that the viewer will find more relevant than the universal default article. One way of allowing such an update is to provide a web page for account maintenance and periodically to send e-mail invitations inviting the update. Such is not the only way, and it is well known within the art to update a demographic profile. Any of the currently practiced means would be applicable.

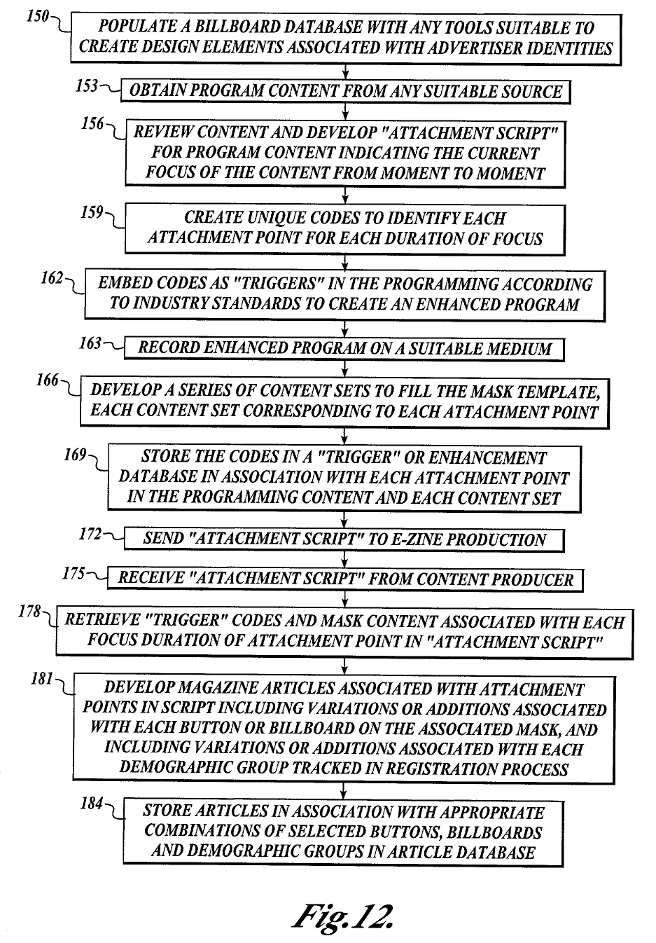

FIG. 12 portrays the process of production of enhanced media. As is common with broadcast media, the service must go out and arrange sponsors for the programming 150. These sponsors would offer graphic art that would correspond in size into a standard set by the producer to populate the slots of the billboard. As HTML is the likely standard of the industry, these graphic elements would likely be in a file format compatible with HTML, such as jpegs or gifs. These graphic images would be stored in association with the identity of the particular sponsor in a billboard database. Because of the association of these sponsors and the supporting graphics, the producer's desktop 110 easily constructs masks and e-Zines containing references to the advertising sponsor. At 153 the producer obtains program content from any suitable source and at 156 reviews the content and develops an attachment script for the program content indicating the current focus of the content from moment to moment. As indicated in the discussion above, this attachment script describes the various attachment points within the video program and is suggestive of the article content appropriately associated with the attachment points. As indicated above, the producer has the choice of keeping the same mask throughout the show or varying the mask from topic to topic as the focus of the video programming changes.

Based upon the attachment scripts, the producer creates unique codes, or “triggers” to identify each attachment point as the producer sees fit. These codes, as indicated above, can be URL's or concatenated numeric codes. In any regard, these codes are imbedded at 162 in the programming according to industry standards to create an enhanced program. In its imbedded state, the video content is then recorded onto a non-volatile medium in order to allow for distribution through a broadcast system. Once the attachment script is formed and the triggers are imbedded in the programming, at 166 the producer develops appropriate masks to correspond with the imbedded triggers. These the producer stores at 169 in a trigger or enhancement database in association with each attachment point in the programming content in each content set. It is important to note that the masks stored in association with each trigger may be varied from time to time. For instance, where the content might be a movie such as Tora Tora Tora, the attachment points in the movie might remain constant, but the masks associated with that movie might vary from showing to showing. If a network chooses to show the movie in July, where one set of sponsors might include United States Navy Recruiting, a showing in December might include historic tours of Hawaii in the billboard slot formerly occupied by the United States Navy. Though the triggers remain constant in both showings, the content stored in association with those triggers, or in the case of the preferred embodiment, at the URL's as masks, would vary from showing to showing. This fact proves the inherent flexibility of the inventive method. Once all of the masks are composed, at 172, the attachment script is sent or stored in a fashion to give access at the time of e-Zine production. Thus at 175, the script is available to the e-Zine content producer along with the trigger codes at 178. Thus the e-Zine producer develops magazine content based upon the known focus of the video programming at the attachment point and associated with each button or billboard in the associated mask, including variations or additions associated with each demographic group tracked in the registration process 181. At 184 the e-Zine producer stores these articles in a manner consistent with the described article database above.

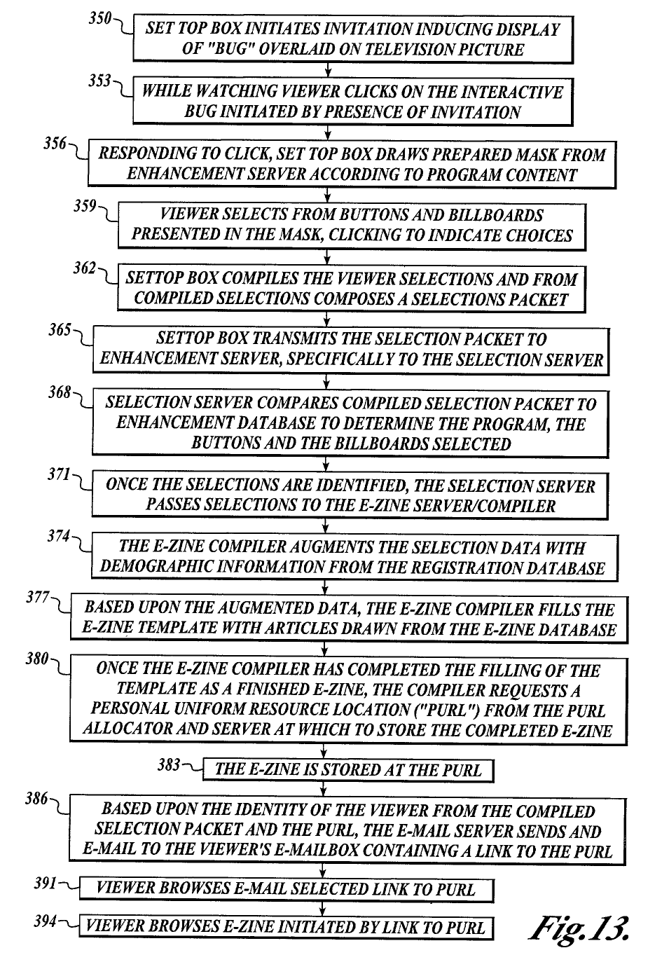

FIG. 13 describes the inventive method commencing at the point where the system presents the viewer the opportunity to interact with the video content. At 350, the set top box initiates an invitation inducing the display of the bug 221 overlaid on the video picture portrayed on the screen 220. This indicates to the viewer that the system is ready to respond to any of the viewer's requests for content. In the course of watching television, something the viewer sees in the video content on the screen evokes the viewer's interest, causing the viewer at 353 to initiate the process of interactive dialog with the inventive system. At 356 the system responds to the viewer by filling the screen with the mask portrayed in FIG. 5 or a variant thereof based upon content selected by the producer. As indicated above, the preferred method of filling the screen is to draw a completed mask from the URL that is stored as a trigger imbedded in the video programming. An alternate embodiment of the invention allows for the composition of the mask based on codes imbedded in the video content.

At 359 the viewer selects from among the several buttons and billboards presented by any appropriate means, though a navigating remote control is the preferred embodiment. By a scrolling remote control the invention envisions the ability of the viewer by activating buttons on a remote control to move from one billboard to another and from one button to another, selecting or deselecting them as the viewer sees fit, and finally when the selections represent the viewer's choices to submit by activating the first of the two buttons portrayed at 234. Where the viewer desires all of the buttons and billboards to be selected, they simply activate the second of the two buttons.

Upon submission, at 365, the set top box 210 compiles the viewer's selections and assembles from those selections a selection packet. This the set top box 210 transmits, at 365, by means of the upstream communication link described above to the enhancement server 310 specifically to the selection server therein at 338. The selection server, at 368, to determine the program, the buttons, and the billboards selected at 371 the selections are passed to the e-Zine compiler 341 to build an e-Zine according to those selections. In the manner described in FIG. 10, the e-Zine compiler, at 377 fills the e-Zine template with articles drawn from the e-Zine database. Appropriate billboards are filled in the compiler at 380. Requests from the URL allocator and server 344 a URL at which to store the completed e-Zine. At 383 the compiler stores the e-Zine at the URL on the server.

Once the e-Zine is stored at 383, the e-mail server 347 sends an e-mail containing a link to the URL through the Internet 125 to the consumer's e-mail box. As indicated above, the URL might be a personal uniform resource locator ensuring special behavior of the URL in response to the storing and recalling from that URL. At some later time the viewer reviews the e-mail contained in the e-mail box at 391 and selects the link that directs the viewer's Internet browser to the URL to recall the e-Zine stored there. At 391 the viewer browses the e-Zine and any links contained therein to further URL's on the Internet.

While the preferred embodiment of the invention has been illustrated and described, as noted above, many changes can be made without departing from the spirit and scope of the invention. For example, there might be additional means of requesting the e-magazine such as by means of the use of a telephone rather than a remote control unit and an ASTB. Accordingly, the scope of the invention is not limited by the disclosure of the preferred embodiment.

The embodiments of the invention in which an exclusive property or privilege is claimed are defined as follows:

1. A method for advertising services or goods by means of enhanced video programming comprising:
populating a query database with button faces;
obtaining video programming for enhancement;
identifying attachment points within the video programming for enhancement;
associating button faces from selected queries with each attachment point;
recording the video programming with associated attachment points on suitable medium;
developing content sets associated with each button face and associated attachment point;
storing content sets in association with each button face and associated attachment point in an enhancement database;
retrieving content sets upon viewer activation of associated button face at associated attachment point;
compiling retrieved content sets into e-magazines; and
e-mailing compiled e-magazines to viewer.

2. The method of claim 1 wherein the term button faces comprises logos of potential advertisers.

3. The method of claim 1 wherein the term button faces comprises graphics depicting categories of queries.

4. The method of claim 1 wherein the term button faces comprises masks with both logos of potential advertisers and categories of queries.

5. The method of claim 4 wherein the masks are interactive menus.

6. The method of claim 1 wherein recording comprises placing information at an addressable site on the internet and recording an address for the addressable site with the attachment point.

7. A system for advertising services or goods by enhanced video programming comprising:
a system for pre-production comprising:
a programming source comprising video programming itself comprising a series of attachment points;
a trigger database;
a computer communicatively linked to the programming source and the trigger database; and
a computer software product for associating triggers stored in the trigger database with the attachment points;
a system for viewing comprising:
means of communicating the video programming and attachment points to the advanced set top box; and
an advanced set top box communicatively linked to the trigger database comprising:
means of receiving the video programming and attachment points;
means of generating a television-viewable signal based upon video programming and attachment points;
means of receiving viewer requests based upon the television-viewable signal; and
means of transmitting the viewer requests to an enhancement server;
a system for production comprising:
a content database containing magazine content associated with triggers contained in the trigger database;
means of communicating with the trigger database; and
the enhancement server for:
receiving communicated requests of the viewer;
translating communicated requests of the viewer based upon the associations stored in the trigger database;
retrieving content according to the triggers associated with the viewer request;
compiling an e-magazine based upon the retrieved content; and
e-mailing the compiled e-magazine to the viewer.
